(19) United States
(12) Patent Application Publication
(10) Pub. No.: US 2017/0345323 A1
(43) Pub. Date: Nov. 30, 2017

(54) EDUCATIONAL APPARATUS

(71) Applicant: CORK INSTITUTE OF TECHNOLOGY, Cork (IE)

(72) Inventors: Juan Francisco MARTINEZ SANCHEZ, Cork (IE); Kevin O'MAHONY, Cork (IE); Stephen COLLINS, Macroom, County Cork (IE); Jian LIANG, Blackrock, County Cork (IE); Gary SMITH, Youghal, County Cork (IE)

(73) Assignee: CORK INSTITUTE OF TECHNOLOGY, Cork (IE)

(21) Appl. No.: 15/534,087

(22) PCT Filed: Dec. 21, 2015
(86) PCT No.: PCT/EP2015/080877

§ 371 Date: Jun. 8, 2017

(30) Foreign Application Priority Data
Dec. 22, 2014 (EP) 14199813.8

(51) Int. Cl. G09B 5/06; G09B 5/14; G09B 5/10

(52) U.S. Cl. CPC G09B 5/062; G09B 5/10; G09B 5/14

(57) ABSTRACT

An educational apparatus has a controller linked with student devices, and a teacher device. Each student device is in the form of a desk with a board, a touch sensor array in the board, a display physically separate from the array, and permanent indicia. The apparatus recognises touch by a student on the board, and this is mapped to content of an overlay sheet of paper placed on the board. Moreover, multiple devices may be juxtaposed, and events may be recognised based on all of the group of devices together. An example is a paper sheet covering four devices together and having a map printed on it, in which the software recognised a particular location of touch on a particular device as being a specific region on the map.

### INTRODUCTION

### Field of the Invention

The invention relates to an educational apparatus for use especially in classrooms.

### Prior Art Discussion

US2012/0202185 (E3 LLC) describes a network with student devices with touch screen displays. US2013/0173776 (Marvell World Trade) also describes classroom devices wirelessly interconnected. US2014/0356843 (Samsung) describes a portable apparatus with a touch screen with input user identification. US2014/0125620 (Fitbit) describes a touchscreen device with dynamically-defined areas having different scanning modes.

There is a need for improved technical tools which assist teachers in accurately assessing performance of individual students, and also for providing interesting teaching which is more likely to stimulate the student, especially young students at primary school level.

The invention is directed towards providing such an apparatus.

### SUMMARY OF THE INVENTION

According to the invention, there is provided an educational apparatus comprising:
a plurality of student table top devices, each device comprising:
   a board with a touch sensing array, and
   a local feedback component physically separate from the touch sensing array and arranged to provide user feedback,
   a wireless interface for communication;
a teacher display; and
a controller configured to:
   recognise an event associated with touch at a particular position on each student device, including mapping content printed on an overlay sheet placed on the board by a user with location of parts of the sensor array, and
   generate a display on the teacher display to provide feedback of events arising from student touching at the student devices.

In one embodiment, the controller is configured to dynamically perform said mapping according to expected printer overlay sheet to be used.

In one embodiment, at least one device has indicia permanently marked on the board surface over a sensing array, and the controller is configured to perform static mapping of content of said indicia with sensor array positions. In one embodiment, said permanent indicia are alongside a region for placement of an overlay sheet by a user.

In one embodiment, the board includes a physical guide for registration of an overlay sheet over a sensor array.

In one embodiment, said guide comprises a ridge for abutment with an overlay sheet.

In one embodiment, said feedback component comprises a display device.

In one embodiment, the controller is configured to recognise an event by mapping content of an overlay sheet to parts of sensor arrays of a plurality of devices in juxtaposed positions.

In one embodiment, at least some student devices comprise neighbour sensing components for sensing neighbour student devices. Preferably, said neighbour sensing components include wireless interfaces. In one embodiment, said neighbour sense components are configured to upload to the controller an identifier of a sensed neighbour student device.

In one embodiment, the controller is configured to monitor and output information defining relative physical positions of a plurality of student devices. In one embodiment, the controller is configured to identify sub-networks of devices. In one embodiment, at least one board comprises a neighbour sense component at each corner of the board.

In one embodiment, at least some devices are configured to perform inductive coupling sharing of electrical power.

In one embodiment, the controller includes a processing core in each device, said core being configured to co-ordinate components of its associated device. Preferably, the controller is configured to arrange a plurality of devices in a group according wireless communication with the devices.

In one embodiment, the controller is configured to recognise as events a pattern of touch by a student as being indicative of student behaviour.

In one embodiment, the sensor array of at least one student device comprises an array of touch sensing electrodes, conditioning circuitry, and a local processing unit for excitation and data acquisition of and from the touch sensors, and in which the touch sensing is based on mutual projected capacitance. In one embodiment, said local processing unit is configured to tune a sensor array sub-section in terms of sensitivity and volume of the electromagnetic field around the sensing elements within the array.

In one embodiment, the local processing unit is configured to provide sensitivity for sensing of touch on a book/printed material placed on the board. In one embodiment, the local processing unit is configured to provide sensitivity for sensing of placement of an article on the board.

In one embodiment, the sensor array comprises sub-arrays with different sensitivities. In one embodiment, each board has a top layer of wood material.

In one embodiment, at least some devices are integrated in desks.

In one embodiment, the layer of wood material includes a coating such as varnish for physical isolation of the wood from the environment. In one embodiment, the wood layer is adhered to a polycarbonate layer or layers. In one embodiment, the sensor array is beneath the polycarbonate layer or layers. In one embodiment, the board comprises a structural substrate of wood material beneath the sensor array.

In one embodiment, the controller is configured to receive data from the student devices through a primary networking interface, and to process and forward data to a local or remote storage location through a secondary network interface.

In one embodiment, the apparatus is arranged to form sub-networks of devices in which a device operates as a gateway of a sub-network.

In one embodiment, network socket technology is applied in communication between a teacher software application and student software applications through middleware software.

In one embodiment, the middleware is configured to initiate a socket server, and said applications and the devices are configured to listen for messages emitted by the middleware.

In one embodiment, a messaging protocol is defined to serve all entities involved in communication for the purpose of differentiating devices in the apparatus, and/or differentiating instances of education modules, and/or differentiating input messages from different devices, and/or managing progresses between instances of the applications.

Additional Statements

According to the invention, there is provided an educational apparatus comprising a controller linked with a plurality of student devices, and a teacher device, each student device comprising a board, a touch sensor array in or on the board, and in which the controller is configured to recognise an event associated with touch at a particular position on each student device, and wherein the controller is configured to generate a display on the teacher device to provide feedback to the teacher of events arising from student touching at the student devices.

In one embodiment, the controller is configured to recognise an event by mapping physical positions on an overlay sheet with location on a board. In one embodiment, the controller is configured to recognise an event by mapping an overlay sheet to a plurality of devices in juxtaposed positions. In one embodiment, the controller includes a device core component in each device. In one embodiment, each device includes transmitters and receivers for communicating with adjacent devices.

In one embodiment, the controller is configured to arrange a plurality of devices in a group according to mutual detection performed by the devices using said transmitters and receivers or alternatively proximity detectors.

In one embodiment, each device has indicia permanently printed or embedded on the board's surface, and the controller is configured to recognise relevant events for touching these indicia.

In one embodiment, the indicia include basic learning indicia such as the alphabet and/or numbers.

In one embodiment, each device includes a display for feedback.

In one embodiment, each device has a sensing array which is retro-fitted underneath the board. In one embodiment, each board is of wood material. In one embodiment, at least some devices are integrated in desks.

In one embodiment, the controller is configured to recognise as events a pattern of touch by a student as being indicative of student behaviour. In one embodiment, the controller core component is configured to co-ordinate the components of its associated device.

In one embodiment, each device has wireless transceiver for communicating with both other student devices and with the teacher device.

In one embodiment, the sensor array comprises an array of touch sensing electrodes with supplementary conditioning circuitry and a local processing unit for excitation and data acquisition of and from the touch sensors, and in which the touch sensing is based on mutual projected capacitance principles. In one embodiment, the touch sensing array provides a multi-touch interface, facilitating multiple points of input via touch and support gesture interaction, for example, drag and drop, swipes, and/or rotate.

In one embodiment, the touch sensing array is able to detect interaction of the student with passive or active objects placed on the device's surface, such as wooden blocks or rubber chips.

In one embodiment, the sensor array has areas with different sensitivities. In one embodiment, a sub-section has higher resolution allowing for the implementation of literacy and tracing exercises, for gesture and signature recognition. In one embodiment, the controller is configured to identify and map students and devices so they can be identified and logged in. In one embodiment, a sensor array sub-section can be tuned, for example in terms of sensitivity and volume of the electromagnetic field around the sensing elements within the array, in such a way that a book could be placed down on the table and the students could select their answer by touching the appropriate picture in the book.

In one embodiment, the sensor array is configured to perform some or all of the following activities: process single touch and multi-touch events, and/or calibration through firmware of the touch sensing layer, both locally and remotely, and/or dynamic calibration through firmware of the touch sensing layer, depending on the user preferences and/or physical constraints.

In one embodiment, at least one device includes a neighbour sensing component for automated detection of surrounding device, wherein said sensing is contactless. In one embodiment, the neighbour sense component comprises a plurality of sensing elements, for example one at each corner of the board.

In one embodiment, the neighbour sense component is configured to provide information about relative position and orientation within a group, and is configured to provide information to allow power and networking management of the devices to be optimised when within a group.

In one embodiment, the controller is configured to receive data from the student devices through a primary networking interface, to process and forward data to a local or remote storage location through a secondary network interface. In one embodiment, the apparatus is arranged to share power between devices, especially juxtaposed devices.

In one embodiment, the apparatus is arranged to form sub-networks of devices in which a device operates as a gateway of a sub-network for communication purposes in order to, for example, save power or reduce contentions of data through wireless interfaces.

In one embodiment, the apparatus is configured for information exchange between coupled elements around the perimeters of devices.

In one embodiment, the apparatus is configured for seamless user identification and logging to a device.

In one embodiment, network socket technology is applied in communication between teacher software applications and student software applications through middleware software. In one embodiment, the middleware is configured to initiate a socket server, and said applications and the devices are configured to listen for messages emitted by the middleware.

In one embodiment, a proprietary messaging protocol is defined to serve all entities involved in communication for the purpose of differentiating devices in the apparatus, and/or differentiating instances of education modules, and/or differentiating input messages from different devices, and/or managing progresses between instances of the applications.

### DETAILED DESCRIPTION OF THE INVENTION

### BRIEF DESCRIPTION OF THE DRAWINGS

The invention will be more clearly understood from the following description of some embodiments thereof, given by way of example only with reference to the accompanying drawings in which:

FIG. 1 is a perspective view of a table device of an apparatus of the invention;

FIG. 2 is a block diagram showing the major components of the device;

FIG. 3 is a block diagram showing an educational apparatus of the invention incorporating multiple devices, and FIG. 4 is a diagram showing logical interaction of the functional blocks of the apparatus;

FIGS. 5(a) and 5(b) are plan views of alternative capacitive touch sensor arrangements for devices of the invention;

FIG. 6 is an exploded perspective view of a device showing a number of layers in its construction;

FIG. 7 is a perspective view showing an alternative device, FIG. 8 shows layers in its construction, and FIGS. 9, 10, and 11 are diagrams showing this device in use;

FIG. 12 is an exploded perspective view showing an alternative device of the invention, and FIG. 13 shows this device in use with the vertical dimension exaggerated for clarity;

FIG. 14 is a plan view showing an alternative device in use, in this case having only one sensor array;

FIG. 15 is a perspective view showing a device in use with sensing of objects on the table top;

FIGS. 16 and 17 are diagrammatic plan views showing wireless coupler component locations, and two examples of mutual juxtaposed positions of devices;

FIG. 18 is a logic flow diagram illustrating operation of the apparatus, especially for mapping of overlay sheets with sensing in the sensor array; and

FIGS. 19, 20, and 21 are flow diagrams illustrating other aspects of operation of the apparatus.

### DESCRIPTION OF THE EMBODIMENTS

Overview

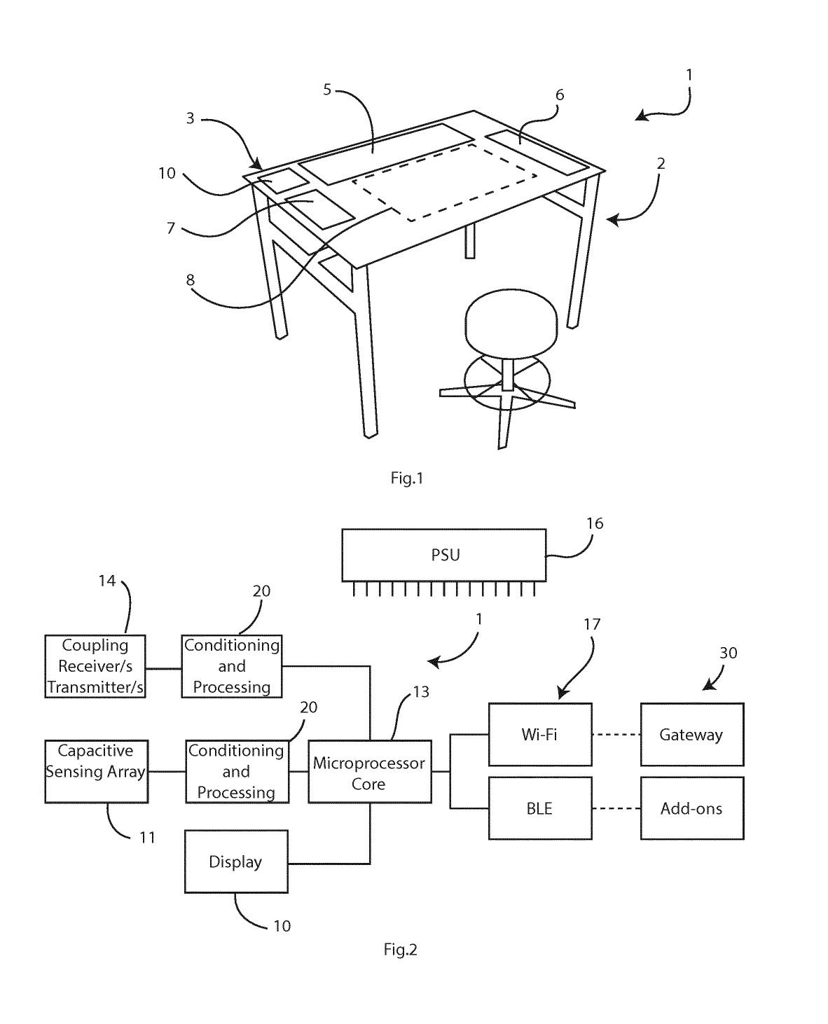

Referring to FIGS. 1 to 6 an educational apparatus 1 comprises multiple student table devices 1. Each device 1 is in the form of a desk or table having a frame 2 with legs and a multi-layer table top 3. The table top 3 has indicia sections 5, 6, and 7, a dynamic sensor region 8, and a display 10.

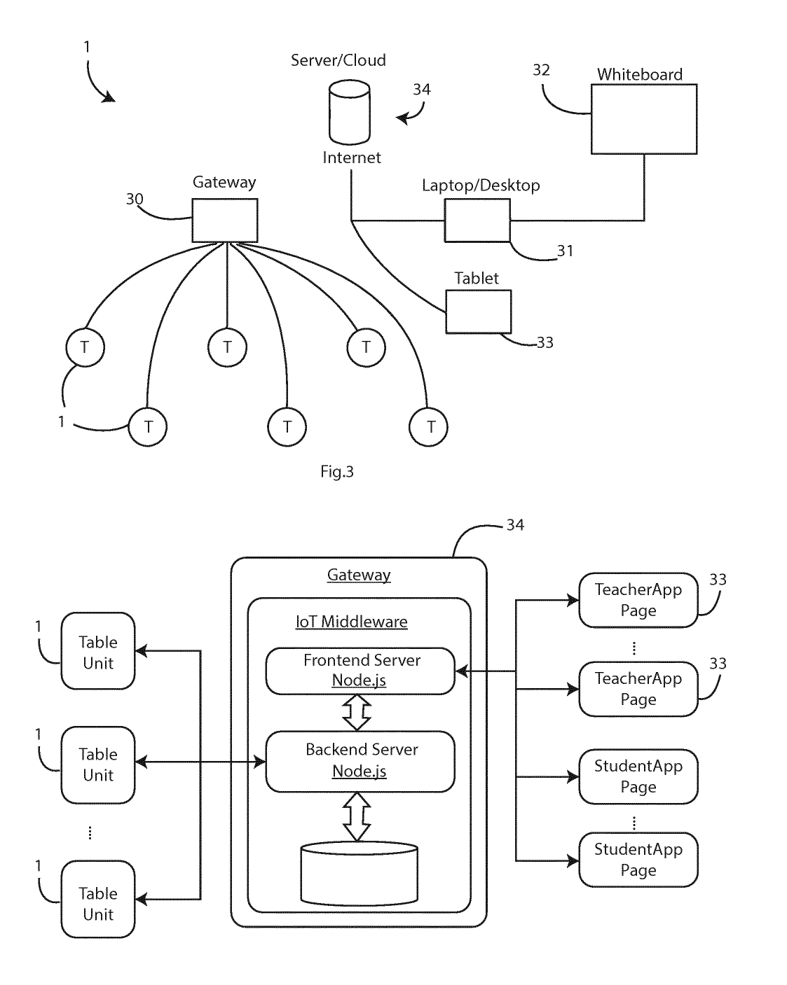

Referring specifically to FIG. 2, each device 1 also comprises within the table top layers:
11, a touch sensing capacitive array,
13, a main processing core component,
14, a coupling receiver and transmitter for neighbour device sensing,
16, power supply unit (PSU),
17, wireless network interface; and
20, signal conditioning and processing circuit interfacing between the items 11 and 14 and the core processor 13.

FIG. 6 shows the arrangement of the device 1. The table top 3 has a substrate 45, the sensor array 15, and a top layer 46 with a display 47 and permanently printed indicia. In one example, the indicia are numbers 48 and the alphabet 49.

Hence, the device can be used for basic education such as number and letter learning without need for an overlay sheet at any particular time.

The coupling and sensing components 14 and 11 are connected to conditioning and processing circuits 20, and together with the display 10 are linked to the core processor 13. All of the devices 1 of an apparatus communicate with a gateway 30, using their wireless interfaces (WiFi and Bluetooth).

Referring specifically to FIGS. 3 and 4 the gateway 30 is linked with a teacher computer 31, in turn linked with a whiteboard 32. There is also a tablet computer 33, and the various computers and the gateway are linked to servers 34, in this case via the Internet.

The main logical interfaces within the server architecture 34 are shown in FIG. 4. These include IoT Middleware, and JavaScript front end and back end server nodes.

The physical structure of each device 1 is that of a robust piece of furniture, the table top 3 being capable of withstanding the usual wear and tear of a student desk.

The apparatus software is configured to dynamically map content of each of multiple overlay sheets of paper or other material such as plastics with sensors in the device sensing arrays 11. Accordingly, touching a part of an overlay sheet which has been accurately placed over the dynamic sensing sub-array 8 of the array 11 will be sensed and linked by the apparatus to an item of content at a particular location of the overlay sheet. In a simple example an overlap sheet is a set of images of animals and touching of an image of a particular animal when requested to do so is registered as being correct or incorrect by the apparatus. The request takes the form of questions on the whiteboard 32.

When subsequently, a different overlay sheet for a different set of content images is placed on the table top 3 the apparatus will map differently, and correspond sensor elements with the new overlay sheet.

There may be correlation of an overlay sheet with sensor arrays of multiple juxtaposed tables 1, for additional versatility.

Also, in some embodiments, as described in more detail below, some sensor array 11 sections are permanently mapped to content, and this content is marked as indicia on the table top 3. A typical example is the alphabet letters, or numbers. These are static array sections 5, 6, and 7 of the device 1, the arrays for sensing of touch over an overlay sheet being dynamic array sections.

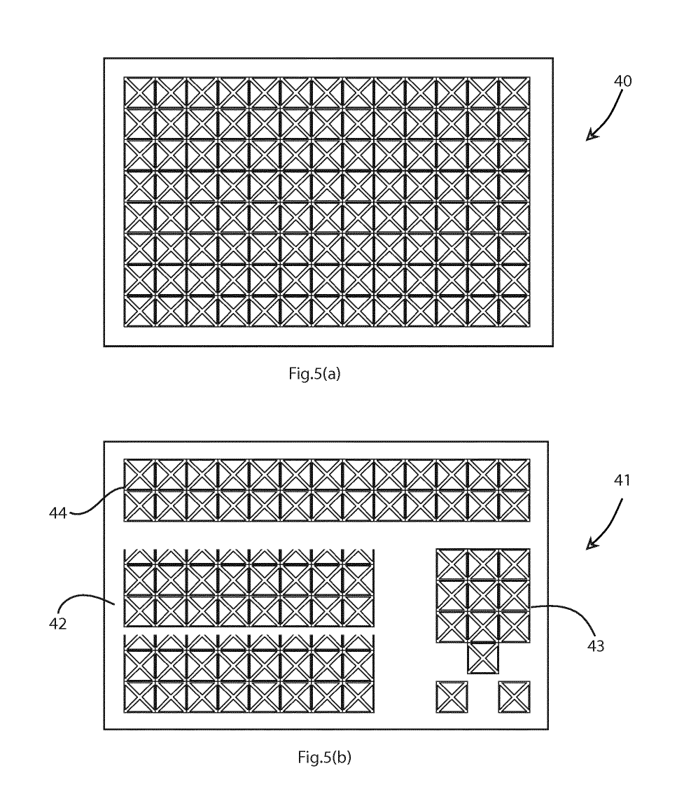

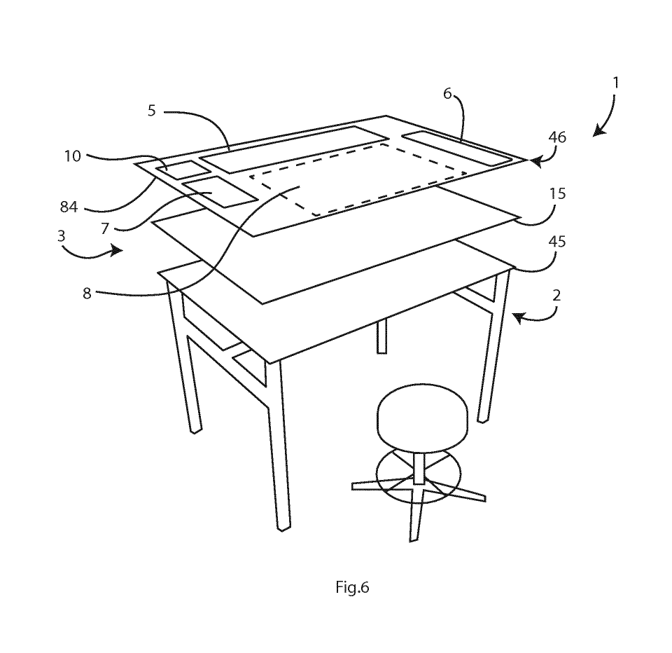

Possible sensor arrays 40 and 41 are shown in FIGS. 5(a) and 5(b). In both cases, the array comprises triangular capacitive electrodes. In the array 40 all of the elements are treated by the apparatus software as dynamic, meaning that they are only mapped to content on a dynamic basis in software in the apparatus. In the array 41, there are three sections namely a dynamic section 42 and static sections 43 and 44. FIGS. 5(a) and 5(b) therefore show that there may be any desired configuration of sensors to suit the desired teaching application. It is preferred that there by static sections, but this is not essential.

The display 10 is driven by the core processor 13 to provide locally feedback to the student, according to touch on the table top 3. Alternatively or additionally it may provide instructions to the student. It is preferred that the apparatus include a general display device such as the whiteboard 32, and additionally a local display device on each device. It is envisaged that each device may have a sound emitter and/or haptic transducer for student information feedback instead of or in addition to a local display.

Physical Structure Aspects

Each device 1 has physical strength and ability to withstand wear and tear like a typical item of furniture. It is preferred that the top layer be of wood, however, this needs to be combined with other materials in order to achieve the desired properties having a high dielectric value, very little physical distortion from planar, and avoidance of air bubbles. It is preferred that the top layer of wood be bonded to a polycarbonate layer, and it is also preferred that there be a varnish (or other protective coating) on top to provide enhanced resistance to wear and to prevent change in properties with the ambient conditions. Without such a protective layer the wood might, for example, absorb excessive moisture in an environment with a high humidity.

The depth of the layer or layers of polycarbonate is chosen to achieve optimum flatness and dielectric value. It is desired that the dielectric value be above 5. Multilayer stack-up of materials achieves shielding and protection of the sensing layer against noise, mainly from the display. Also, the multi-layer structure achieves robustness, stability and performance through materials with very low dielectric constants (i.e. wood) compared to the ones used on typical touchscreen applications (i.e. glass, polycarbonate).

The device may include any of the following materials, provided the desired physical strength, sensing, and predictability of behaviour is achieved: glass, polycarbonates, Perspex, plastics, silicon or rubber compounds, plaster, concrete, paper, cardboard, wood, wood veneer, ceramic, and/or stone.

The sensing arrays 11 have been developed as being inter-connectable and behave as “plug and play” devices that, once are linked, act as a single one. Depending on the application, different sensing electrodes designs and distributions, and different materials may be used. The electrodes have a triangular shape in this embodiment, but may alternatively have an inter-digitated arrangement or be of diamond shape for example.

The following describes physical arrangements in various embodiments.

Laminated (Underlay)—Retrofitted.

A sensing layer is placed underneath the surface after manufacture with all relevant circuitry attached. A small lodgement cavity is required.

Multi-Layer Arrangement

The sensing layer is placed inside the surface during manufacture with or without all relevant circuitry attached. They can be added afterwards using the slot-in approach. Integration is done at manufacturing time with minimal cost impact, and reliability and performance of the device can be assured because parameters such as materials, thickness are fixed at manufacturing.

Top Lamination.

A sensing layer is placed on top of a surface after manufacture with all relevant circuitry attached. A small lodgement cavity may be required. High sensing resolutions can be achieved, and this approach allows excellent modularity for versatility during manufacture.

Deposition/Printing Techniques: Use of Conductive Paints/Inks

Compositions for this technique are commercially available, for example with nanoparticles of conductive material in suspension. Their resistivity when deployed varies depending on the geometry of the electrode's shape. It can be applied by inkjet printer, by spray, and/or by brush depending on targeted resolution.

Referring again to FIG. 6 the base substrate 45 is of a rigid material, MDF, and a polycarbonate film. The bottom layer of polycarbonate may or may not be included, however, in this embodiment it was included to improve adhesion between the sensor film and the base substrate in this case, while also protecting and adding rigidity to the sensing array.

The sensing array15 comprises capacitive electrodes on a flexible ITO film or polyamide substrate and/or rigid FR4 substrate.

The top layer 46 is of polycarbonate underneath and wood veneer on top providing the top surface. The polycarbonate adds rigidity, avoiding the effect of memory of the material when deformed, but most importantly amplifies the field that propagates from the sensing layer up to the very top, improving performance and stability. While the dielectric constant of the wood may vary, polycarbonates and similar compounds present higher and more homogeneous dielectric constants. The veneer and polycarbonate layers had the same thickness, but this may vary depending on different applications. The wood veneer has a coating layer of varnish providing a coating according to the porosity of the veneer.

Acrylic-based adhesive was used as bonding material between every layer within the stack. The lamination process was done in such a way as to avoid any air gaps/bubbles within the stack as this has a direct impact in the performance due to dielectric variations.

Processing Core 13

The core 13 is the main processing unit of each device 1. The core 13 acts as coordinator of the rest of the device components, handling the data from the touch sensing block, neighbour sense block, network interface (if not integrated) and any other possible hardware add-on regarding local feedback to the user, such as a display, buttons, switches, LEDs and other future extended functionalities. In this way every component will behave as a system on chip device (SoC) running in isolation and communicating with the core 13 when queried. The core 13 acts not only as a coordinator but also as a local gateway within the device.

The processing core 13 device runs on an embedded OS and has GPIO pins for interfacing certain add-on elements such as system state signalling LEDs. It has communication input/output interfaces for peripheral support (i.e. USB, UART, SPI, I2C) in order to accommodate add-on hardware modules. Also, the core 13 has networking capabilities and/or support for the addition of a compatible networking module/s such as Wi-Fi/BLE. There is Flash storage, either on-board or through expansion slots such as an SD card.

Wireless Communications Module 14

This is a multi-point end-to-end network interface to allow low latency/low power wireless communications between devices and a host, taking into account the high contention expected from multiple devices connected. Bluetooth (BLE) and Wi-Fi are employed to achieve a network of tables in which each table behaves as an end device within the classroom using the local gateway to connect to the servers 34.

Each device 1 behaves as a master/slave, being able to act as a peripheral of other devices and/or host device of possible future hardware add-on modules to enhance interaction such as by audio feedback. The wireless communication may support up to 30 devices per classroom and/or 5 peripherals per table. The network module on the table is provided with either PCB/Chip antenna (Wi-Fi/BLE) and is compatible with a/b/g/n, for maximum compatibility with existing platforms and/or of the shelf gateway devices to be used at this stage of the project. Also, it supports Dual Band, 2.4/5 GHz, for maximum compatibility with existing platforms and/or of the shelf gateway devices to be used at this stage of the project.

Touch Sensing Array 11

This comprises sensing elements, conditioning, processing and capacitive sensing functionality. It has an array of touch sensing electrodes with supplementary conditioning circuitry and a local processing unit, which is in charge of the excitation/data acquisition of and from the touch sensors. Examples are illustrated in FIGS. 5(a) and 5(b).

The touch sensing is based on mutual projected capacitance principles; this determines the configuration of the sensing electrodes as well as the conditioning and excitation/data acquisition techniques used. The touch sensing module 11 has a multi-touch interface, facilitating multiple points of input via touch and support gesture interaction, such as drag-and-drop, swipes, and rotation. Also, it provides support for the use of tangibles, being able to detect interaction of the user with passive/active enhanced objects placed on the table's surface, for example wooden blocks, and rubber chips.

The touch sensing surface can be divided in different sub-sections with different resolutions. A centred sub-section may have higher resolution, allowing for implementation of literacy and tracing exercises. This area could allow also for gesture and signature recognition in order to identify and map users and tables so they can be safely identified and logged into the system. A sub-section can be also tuned, regarding sensitivity and volume of the electromagnetic field around the sensing elements within the array, in such a way that a book could be placed down on the table and the students could select their answer by touching the appropriate picture in the book.

Certain fixed areas of the device may have permanent static interactive elements printed or embossed on the table such as ‘Yes-No’ buttons and the full alpha-numeric keyboard, depending on the requirements of the user and/or applications in each case.

The sensing elements may comprise printed circuit board or flexible printed circuit (PCB/FPC), and/or meshed wires, and/or conductive ink or paint. Deployment may be by encapsulation, lamination, and/or deposition and printing techniques.

For encapsulation, the whole sensing units are manufactured in either rigid, flexible substrate or a combination of the two, depending on the case. The electronics are then fully encapsulated using a material that will not only protect them but also may enhance its performance due to the properties that the encapsulant material adds to the sensing electrodes that will use it as dielectric.

The electrodes may be embedded on a flexible encapsulant, such as rubber, mat or rigid encapsulant such as plastics polymer, or plaster tile. The device 1 allows technology to be placed on top of any surface as a dynamic overlay, or to be used as a smart building block, such a tile. The elements may be sandwiched or laminated after manufacture, assuring minimum/maximum performance within certain materials. The fully/partially flexible option allows for ease of storage and deployment. The device does not function while flexing; it is only for ease of storage and deployment.

Supplementary/Add-on Hardware Modules

The device allows the addition of supplementary hardware modules for extended functionality. Through the BLE (“Bluetooth”) interface 17, the table 1 is able to implement a network of peripherals.

These add-ons may be dedicated to the provisioning of extended interaction and/or visual, audible or haptic feedback to the user, for example a speaker, a buzzer, a headset and/or a vibration pad/bracelet to mention some.

One possible use of these peripherals is to allow for seamless user identification and logging to the table device 1. Different technologies may be used for the implementation of this capability by means of coupling of an active/passive wearable device with the table device; for example, NFC (Near Field Communications), BCC (Body Coupling Communications), RFiD (Radio Frequency Identification).

Through the BLE network, the table 1 may behave as a master/slave device, being, for example, able to act as an input peripheral device of other devices such as tablets.

PSU Module 16

This provides a power source and management strategy to meet the needs of the device 1. It includes a battery, regulation circuit, a local management circuit, and a charging interface and/or energy harvester.

Software

The main components are a processing unit, network interfaces, user interfaces, and a power supply. It receives data from the tables 1 through the primary networking interface 17; data is processed and forwarded to the relevant local/remote storage location through a secondary network interface. The core 13 acts as coordinator of the network interface modules 14 (if not integrated) and any other possible hardware add-on regarding local feedback/interaction to/from the user, such as buttons, switches, LEDs and other future extended functionalities.

The gateway 30 comprises an embedded PC with one or more wireless network interfaces and at least one wired network interface will be required in every classroom set up. If contentions are experienced in certain applications/scenarios, a multiple radio approach can be implemented on the gateway side in order to assure good performance of the network.

Referring again to FIG. 4, WebSocket technology is applied in communication between TeacherApp and StudentApp software through IoT middleware of the components 1, 30, 31 and 34. The IoT (Internet of Things) middleware initiates the WebSocket Server 34; then the TeacherApp, StudentApp and Table Units start listening for messages emitted by the IoT middleware. A proprietary messaging protocol is defined to serve all entities involved in the communication for the purpose of differentiating table units 1, differentiating instances of software education modules, differentiating input messages from different table units 1, and managing interfacing between instances of TeacherApp and StudentApp software applications.

The gateway 30 software includes a Linux OS, a Web server (Apache, NodeJS), and a data persistent component (SQL database, NoSQL database). The components 30, 31, 33, and 34 implement server and middleware software to provide RESTful APIs for raw data collection/query, for original touch event query and analytic summaries to external systems, WebSocket connections for runtime management to a table 1, and front end Web application communication to IoT middleware through RESTful APIs.

The device 1 software communicates to the IoT middleware over an Internet connection through RESTful APIs for data uploading, status queries through the RESTful APIs, and status listening over Websocket.

The various software components may be executed on digital processors arranged in any desired physical arrangement. For example, there may be direct interaction between each table 1 and the servers in the cloud, or there may be only local servers, and these may indeed be hosted on a device, regarded as a master device. In the latter case, the whiteboard or other general display may be directly fed by a master device or devices.

Overlay Sheet Mapping

The apparatus software is configured to map content of each of multiple overlay sheets of paper with sensors in the device sensing arrays. Accordingly, touching a part of the overlay sheet will be sensed and linked by the apparatus to the part of the sheet. In a simple example an overlap sheet is a map of a country, and the apparatus senses if a student correctly touches a certain region when prompted by either the teacher orally or visually by the display 10 on the table top. If, then, a different overlay sheet for a different country is placed on the table top 1 the apparatus will map differently, and will map sensor elements with the new overlay sheet.

Management of the overlay sheet mapping is controlled from the teacher computer 21, but it could alternatively be done by any of the computing devices in the apparatus, including locally by a device core 13.

The device table top 3 takes the form of a board which may be of rectangular shape as illustrated, but could be of a different shape which as polygonal. Advantageously, each device 1 is shaped to but against other devices so that they form a combined unit. The mapping extends to correlating sections of an overlay sheet which covers multiple juxtaposed table tops to sensor sections in the devices. For example, if a map overlay sheet overlies four of the devices 1 together, if a student touches a particular country, the apparatus sensor array and software recognises this as being the country shown on the sheet.

Within each device 1, the sensor array 15 has a particular pattern to suit the application.

The apparatus can be configured to keep a soft copy of the work being performed by each student, associated with the hard copy that they have been provided with.

Static and Dynamic Mapping

Some sensor elements are in one embodiment permanently mapped to “static” content such as letters of the alphabet or numbers. This static content is preferably permanently marked as indicia on the table top. In the array 40 all of the elements are dynamic, meaning that they are only mapped to content on a dynamic basis in software in the apparatus. In the array 41, there are three sections namely a dynamic section 42 and static sections 43 and 44.

### Use of the Apparatus in Various Embodiments

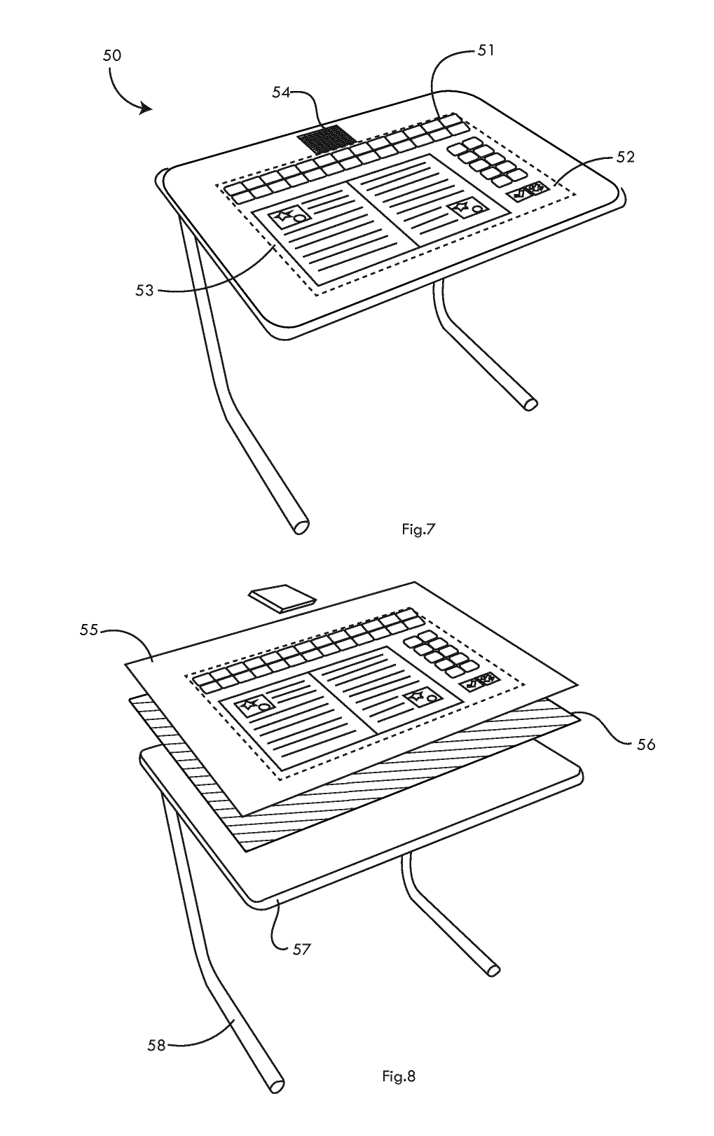

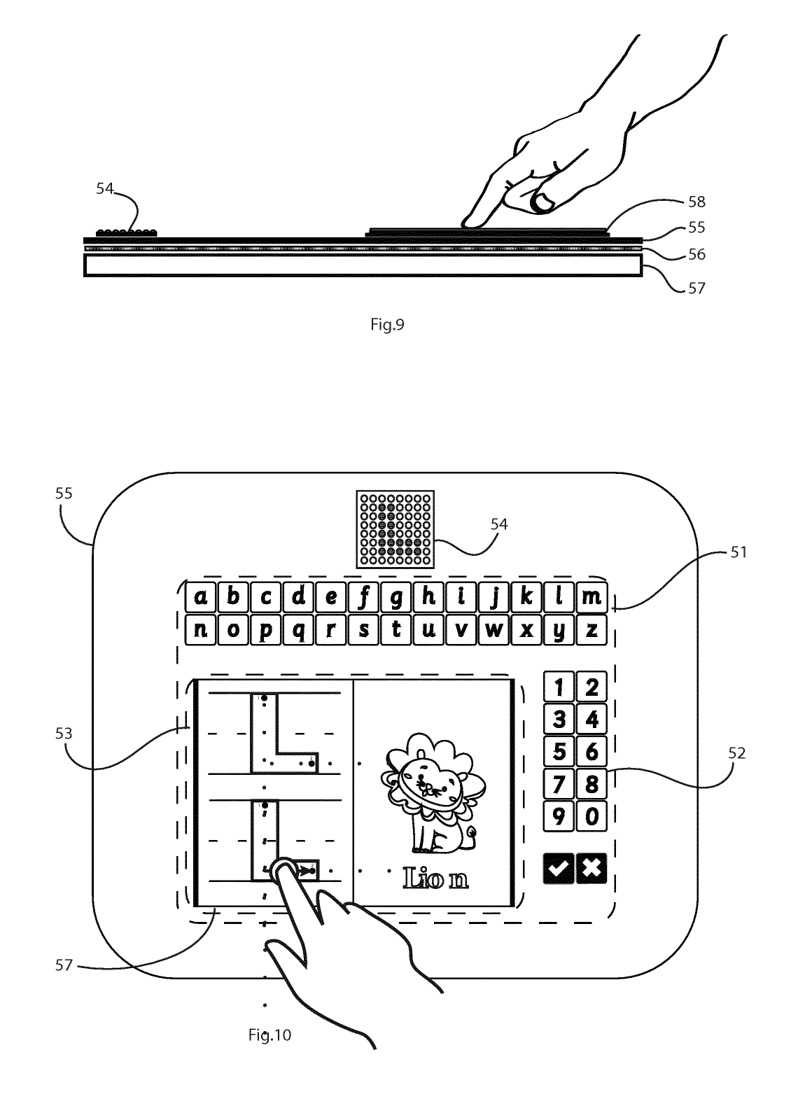

Referring to FIGS. 7 and 8 a device 50 has a wood structure with a sensing array under an alphabet section 51, a number and “Yes”/“No” response section 52, and a section 53 for placing an overlay. There is also a feedback display 54. The structure 50 has a top veneer 55 with the indicia 51-53, a touch sensing array 56, a table top base 57, on legs 58. Use of the device 50 is shown in FIGS. 9 and 10. The student may touch either a part of an overlay sheet 57, and the apparatus software dynamically maps the touch location to content. The apparatus will then provide feedback to the student via a general display such as a whiteboard and/or through the local display 54. It is preferred that there is feedback through the general display so that the teacher can be aware of progress. Referring to FIG. 11 another use of the device 50 is illustrated. As shown, the user presses against a part of an overlay sheet 59, which is temporarily placed on the table top. With a change of settings or configuration in the network can automatically recognise different overlay graphics. A user touches a printed character on an overlay 59 in response to an instruction displayed on the display. This may, for example, be an instruction to touch first a particular character on the overlay 59 and then on the section 51. This aspect of correlating fixed indicia with temporary indicia (on the overlay) is very advantageous for versatility in education.

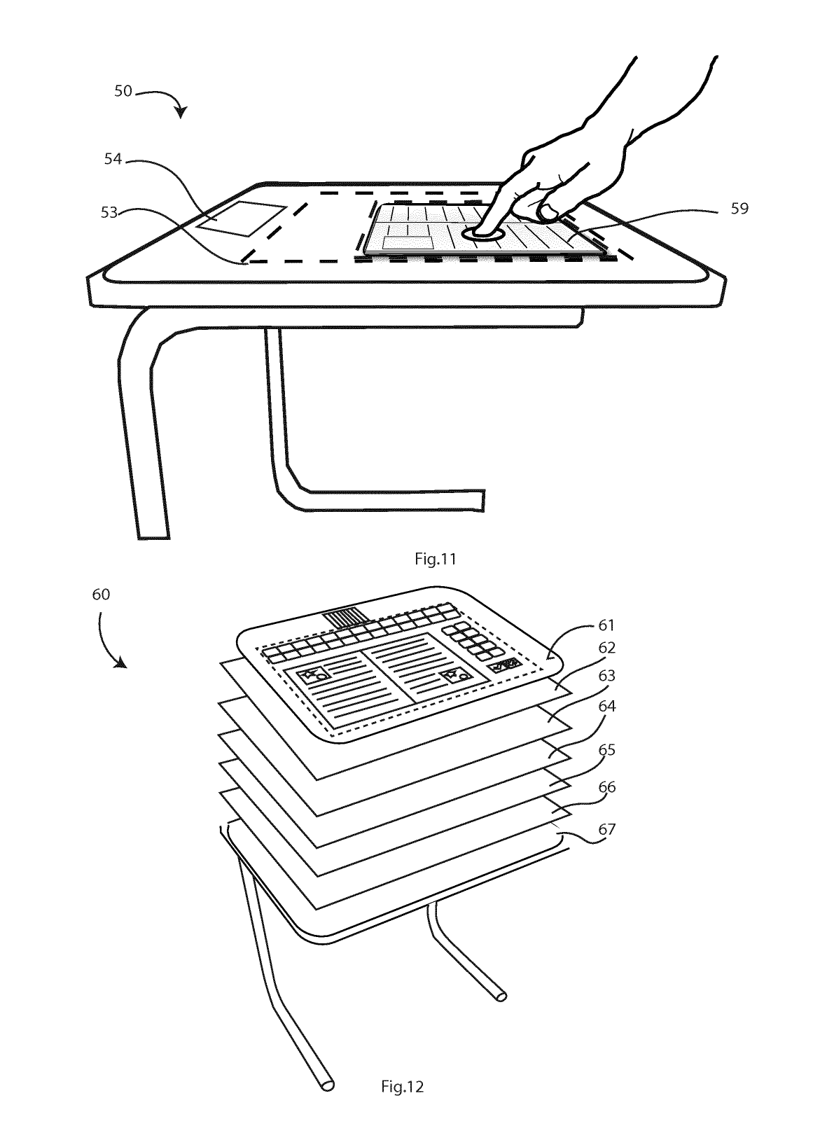

Referring to FIGS. 12 and 13 show the physical arrangement of a device 60, having layers has from top down:
a veneer 61 with permanent indicia,
a top substrate 62 of wood,
a polycarbonate film 63, thickness about 0.5 mm,
a capacitive sensor array 64,
a polycarbonate film 65,
a base substrate 66 of wood incorporating a ground plane, and
a wood structural base 67.

An overlay 68 is shown placed on top in FIG. 13. There is also a display 69.

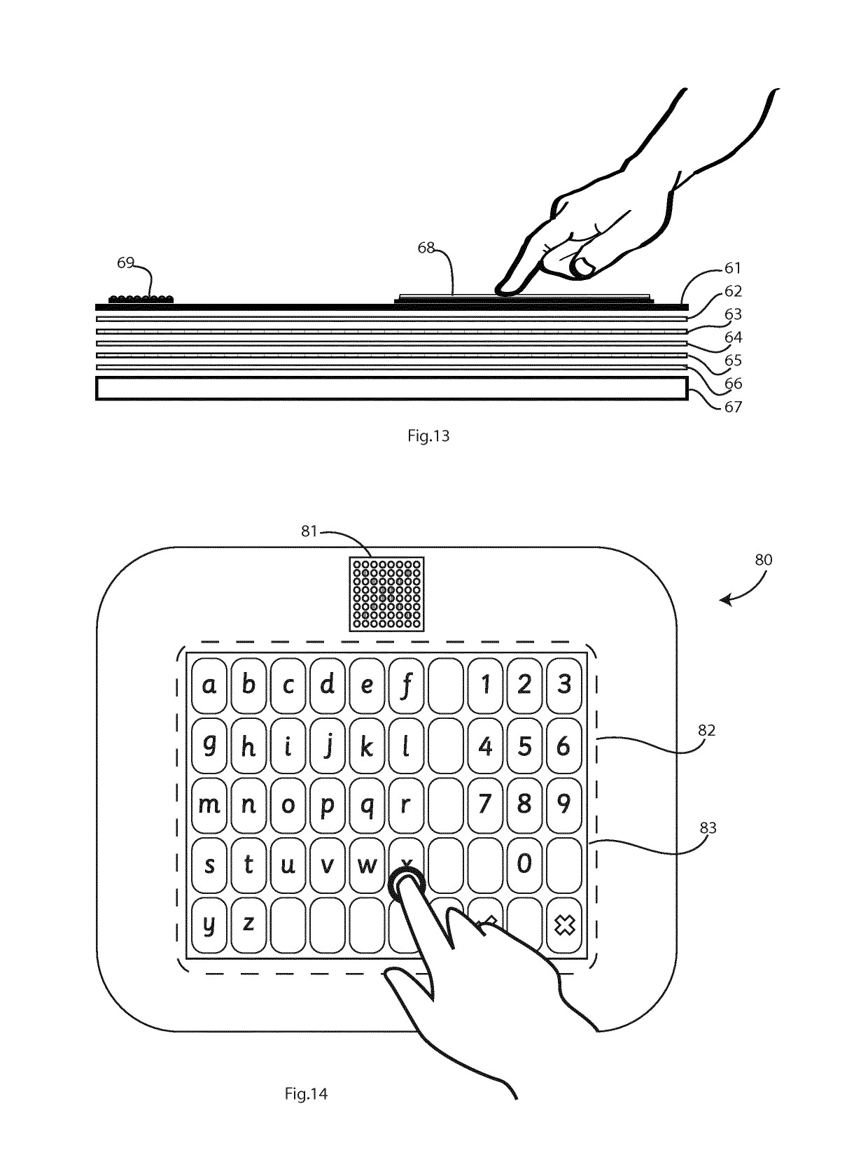

FIG. 14 shows an alternative arrangement of board, 80. In this case there is only a dynamic touch sensing area 82. An overlay 83 is placed on top, for touch sensing interaction as illustrated.

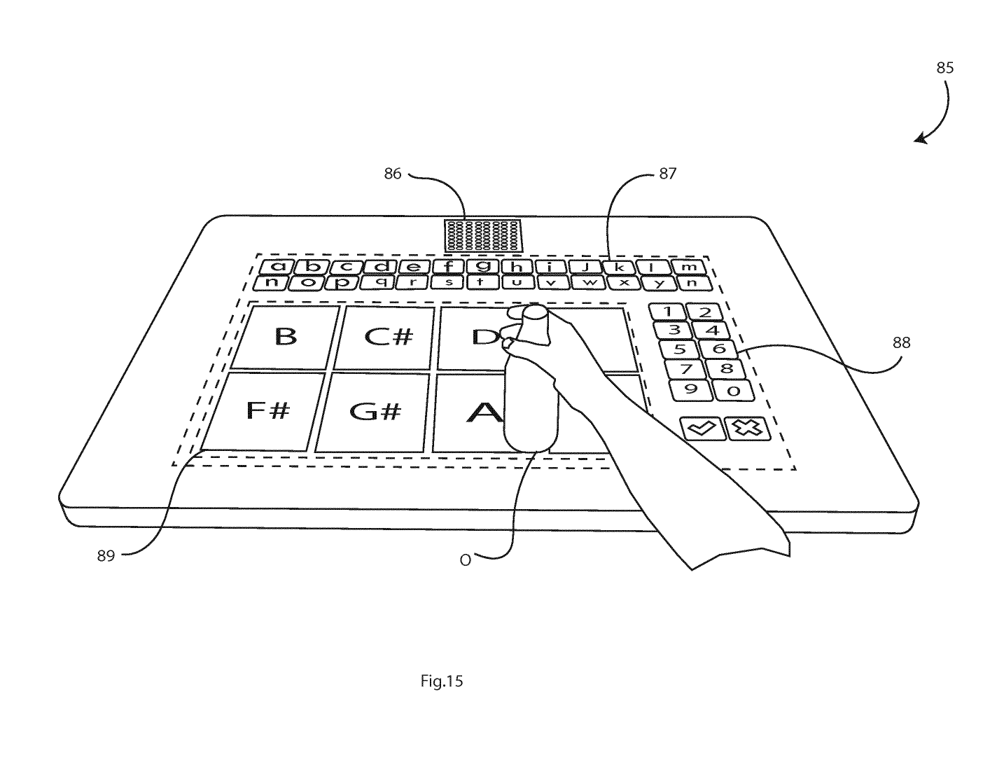

Referring to FIG. 15 a device 85 has a display 86, static array indicia sections 87 and 88, and an overlay sensing dynamic array section 89. The sensors of the array 89 are suitable for sensing objects (O) placed on top.

Neighbour Sensing and Device Combination

The ‘interactive tables’ can also be connected together to create large interactive surfaces so that students can collaborate on activities.

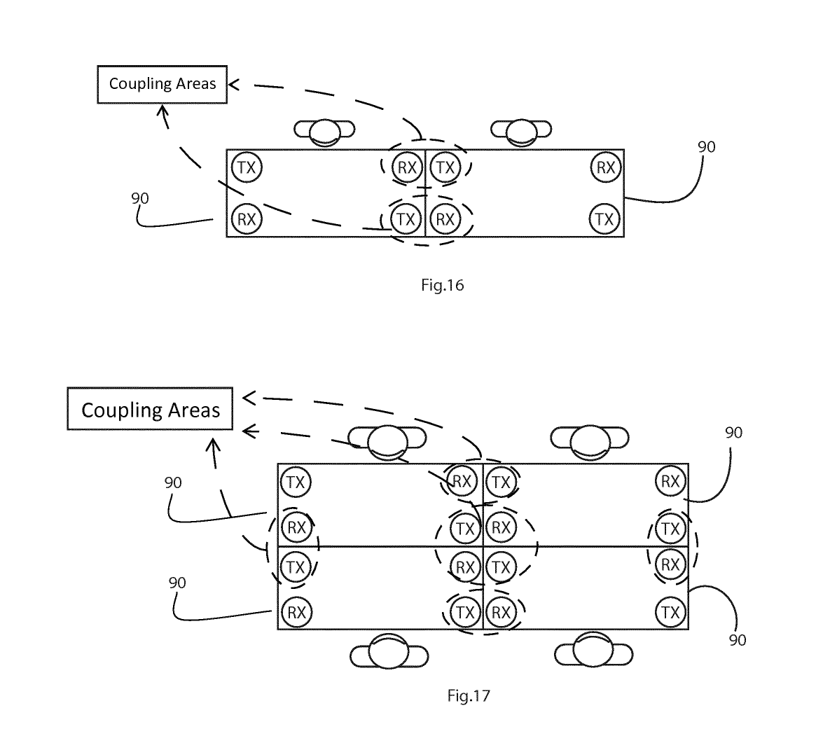

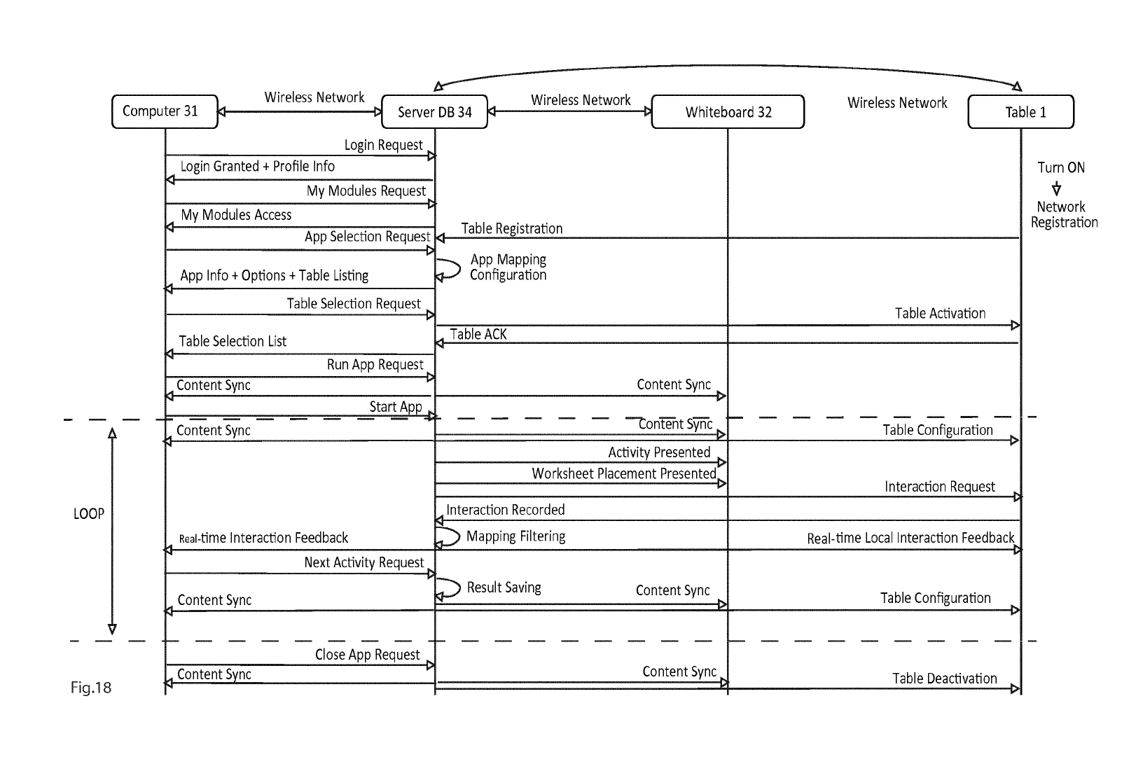

FIGS. 16 and 17 show arrangements in which a device 90 has wireless coupling elements as transmitters TX and receivers RX at alternate corners. These arrangements allow coupling as shown. The coupling is preferably performed using inductive/capacitive coupling techniques. Synchronisation for the inductive/capacitive coupling of receivers and transmitters is governed by services running on the gateway or server derived from a real time clock over the Internet, or alternatively a local clock from a local server. Each device uploads an identifier to identify the device with which it is coupled. The apparatus software then determines which devices are coupled by matching these coupling updates. It is simply on the basis that if a device A indicates that it is coupled to a device B and device B indicated that it is coupled to a device A, then a coupling match is registered.

Transmitter TX and receiver RX are placed alternatively at each corner of the device as shown in FIGS. 16 and 17. In this way no matter how the tables are grouped, coupling is possible. In FIG. 16 coupling between two tables 90 placed side by side is shown. Top and bottom elements of each of the corners adjacent to the neighbour device provide enough information for coupling to take place successfully. Following this configuration, multiple devices can be placed in rows, where coupling takes place on a cascade configuration.

In FIG. 17, coupling between four devices in a 2×2 configuration is illustrated. In this case information is exchanged between coupled elements around the perimeter of the resulting rectangular/square grouped devices. Redundant information is collected so as to avoid possible misunderstanding due to interferences when coupling the receivers and transmitters located in the centre of the group. Following this, configuration groups of for example 2×3 or 2×4 can be also formed and recognised.

Because there is contactless sensing, there is no physical connection between tables, thereby avoiding malfunctioning due to bad connector matching. The apparatus allows connection between tables separated a maximum of 1 to 2 cm for example. The neighbourhood sensing allows not only virtual connection of contiguous devices, but also gathering of information about relative positions and orientations of tables within a group. It also allows for asymmetrical grouping of tables. There may be a dedicated processing unit for driving the neighbourhood sensors, collecting data and performing basic processing tasks, in which case the unit would provide information when queried by the processing core of the table.

The neighbourhood sensing may also provide information to allow power and networking management of the devices to be optimised when within a group.

In another embodiment, the neighbourhood sensing component may have the capability of sharing power between contiguous tables. Also, a combination of the neighbour sensing and apparatus software may allow for sub-networks of tables to be formed when within a group configuration, in which one of the tables may be used as a gateway of the group for communication purposes in order to, for example, save power or reduce contentions of data through wireless interfaces.

Interfacing with the core may be through UART/SPI/I2C or any other custom protocol (1 wire, 2 wire, 3 wire). The neighbour sensing components may also be configured to provide health status information about the sensing elements.

Software Functionality

### Logical Sequence of Pperation:

At table booting, the neighbour sense module 12 is initialized Status of the module is then checked. Once an application that requires grouping of tables is selected, the neighbour sense module 12 on each device 1 is activated. Through coupling between transmitters (TX) and receivers (RX), information about the table Id and relative position of the coupled receiver/s and transmitter/s is exchanged. Synchronization of receiver/s and transmitter/s is governed by the gateway 30 in order to avoid collisions when more than one pair of them is coupled (i.e. see middle area of the four table group) Once the relevant information has been collected by the core 13 on the device, it is sent to the gateway 30 for processing and decision making. When the processing is finished the application will update the layout of the classroom and the graphic representation of the groups.

Referring to FIG. 18 operations performed by the computer 33, a database within the servers 34 and/or the teacher computer 31, the display 32, and a table device 1 are shown for management of mapping of overlay content to sensor elements.

The learning application software running from the cloud/server/database or other location within the apparatus is provided with:
Timing Information:
Information related with the timing of the slides/animations within the learning app and the response expected when questions are displayed.
Image Files:

Images used in an educational software application, including student computer 31 and whiteboard 32 information display.
Audio Files:
Audio used in the application.
Text Files:

Text used in the application
Response Information:
Information related to the formatting of the raw data from the tables 1 received by the application
Sensor Mapping Configurations:

Information for mapping of touch events at the interactive areas required by each learning application.
Table Display Content:
Images and animations shown on the local display of the table device
Table Add-on Content:
Information for interactions performed using peripheral devices such as a headset within the table through wireless interface such as BLE

The device behaves as a data input peripheral device, being able to replace keyboard, mouse and touch-tablet while also offering other ways of interaction. While the table can be dynamically configured over the air, no mapping regarding touch events and/or interactions happens locally on the device; these configuration parameters relate to the calibration and sampling of the sensors in accordance to the requirements of the learning app being run.

All information related to the allocation of interactive areas within the table top and/or worksheets relies on the learning applications themselves. The table captures coordinates and time stamps of touch events. Filtering out of irrelevant touch events and mapping of relevant areas happens in software.

Referring again to FIG. 18, in a use case the teacher logs into an account using a Web browser and access “My Modules” section. The teacher selects an educational module application from a number presented. The teacher is now provided with a description and the option of printing worksheet/s related to certain activities on this application in particular. Alternatively, the activity within the application could be linked to a certain page of a workbook.

Now the application is assigned to all the students in the class. The teacher could alternatively create groups and assign different educational application modules to each individual group. This option requires the use of multiple information displays.

The teacher runs the selected educational application and selects a “screen share” button to synchronize the teacher computer 31 with the information display 32. This will also activate the interactive school desks 1. The educational application is now shown on the information display 32 for the students to view, the local display 10 is enabled and the touch sensing surface of the table is configured in such a way that only the interactive zones relevant to the application are active and/or taken into account.

The teacher then selects the “Start” button. A task or a question is now displayed on the teacher's tablet 31 and on the information display 32 for the students to view. The students are prompted to answer a question or complete a task by tapping the correct answer from the static alphanumeric characters on the table or the worksheet/workbook which is placed at a relatively fixed position within the designated area on top of the interactive school desk. If the students are meant to provide an answer interacting with the worksheet/workbook, they will be prompted about the correct placement and/or page of the same for correct mapping. Otherwise, answers can be provided using the static alphanumeric characters on the table top.

Students select their answer by single tapping a number, letter, or picture from the static alphanumeric characters on the table, or alternatively worksheets/workbooks placed at the designated area. Visual feedback is provided to the students by means of the display 10 integrated on the desk. Real-time feedback is provided to the teacher as the students submit their answers. Once all questions or tasks in an educational application module are completed, the interactive desks automatically will be disabled, where input from the desks are not collected, or local feedback displayed.

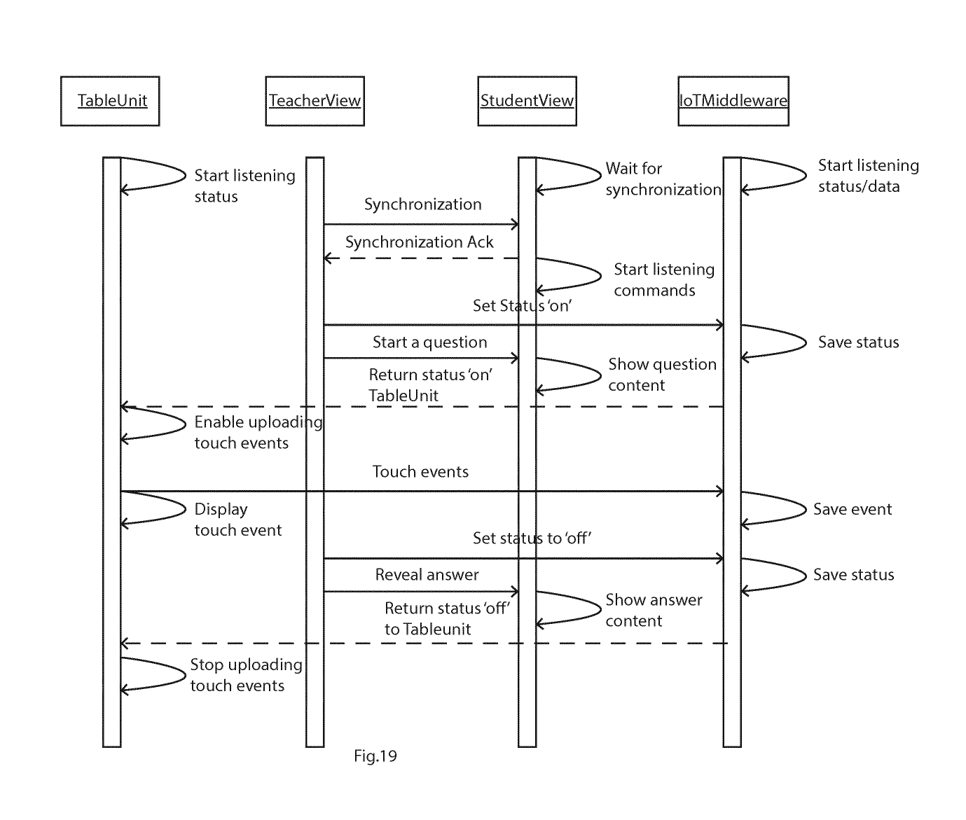

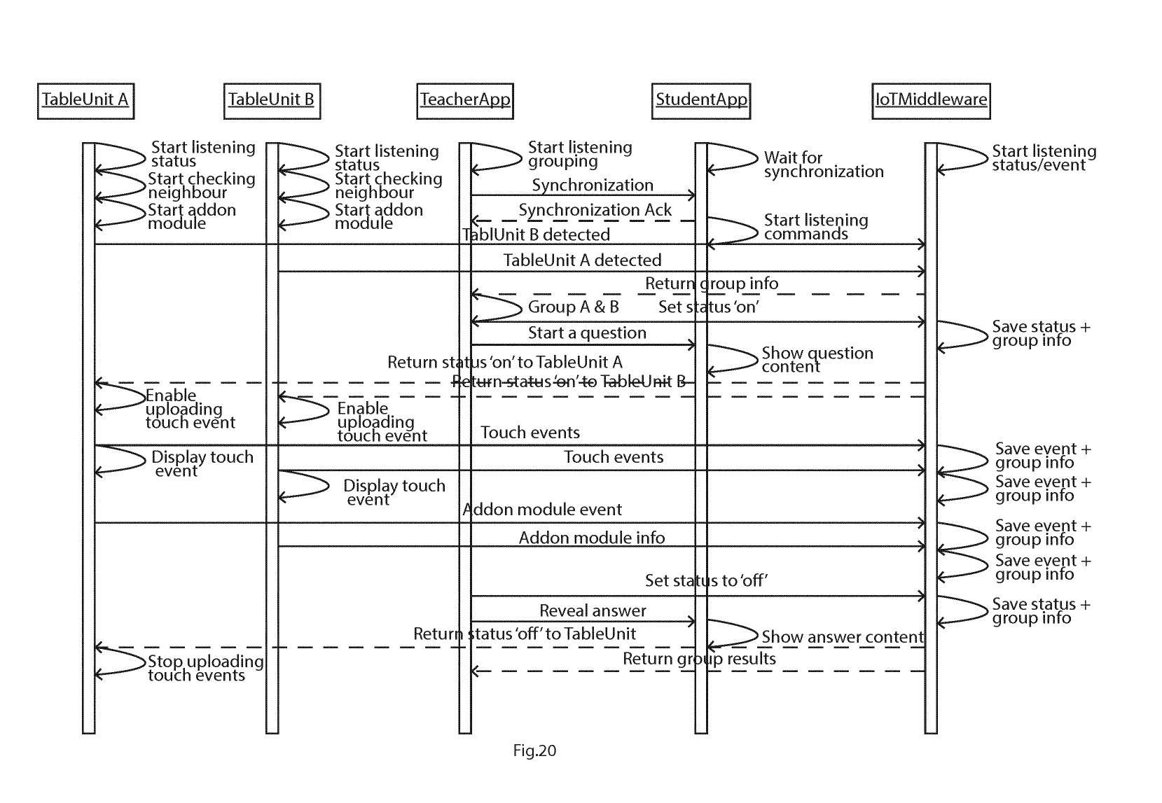

Referring to FIGS. 19 and 20 the following describes other aspects of the apparatus logic flow.
Initialization
   Initiate connection to touch array.
   Initiate connection to display.
   Initiate connection to neighbour sense module.
   Initiate connection to any other add-on module detected/connected to the table through BLE module.
   Create queue for containing touch events.
   Create queue for containing display tasks.
   Create queue for containing IoT middleware tasks.
   Create thread for handling display tasks.
   Create thread for handling Neighbour Sense tasks.
   Create thread for handling add-on module tasks through BLE module.
   Create thread for handling IoT middleware tasks.
   Create thread for handling local timing events.
   Create thread for handling touch events.
   Connect display queue to the touch event thread and the display thread.
   Connect IoT middleware queue to the touch event thread and the IoT middleware thread.
   Connect IoT middleware queue to the display thread and the IoT middleware thread.
   Connect IoT middleware queue to the Neighbour Sense, add-ons and IoT middleware thread.
Main
   Handle error/exception from threads.
   Log main events and errors.
Thread—touch events
   Put event into the display queue.
   Put event into the IoT middleware queue.
   Query the touch array SoC for checking touch events.
   Command the touch array SoC for recovering from errors if errors are detected.
   Put a message into the queue connected to the display thread.
   Put a message into the queue connected to the IoT middleware thread.
Thread—IoT middleware
   Listen to the IoT middleware queue.
   Put event into the display queue.
   Connect to status channel of the IoT middleware server periodically checking status
      Status “on”—retrieved sensed touch events will be uploaded.
      Status “off”—retrieved sensed touch events will be discarded.
      Other status will be put into the display queue for update the local indication on the display.
   Upload retrieved sensed touch events through the queue to the matched data channel of the IoT middleware server when the status is “on”.

If the IoT middleware thread does the query to server, with different status, it will perform differently. The frequency of query is controlled by the local timing thread.
Thread—Display
   Listen to the display queue.
   Display retrieved sensed touch events through the queue from the touch event thread.
   Display retrieved status events through the queue from the IoT middleware thread.
Thread—Neighbour Sense
   Put event into the IoT middleware queue.
   Query the neighbour sense SoC for checking coupling events.
   Command the neighbour sense SoC for recovering from errors if errors are detected.
   Put a message into the queue connected to the IoT middleware thread.
Thread—Add-on modules
   Put event into the IoT middleware queue.
   Query the BLE SoC for checking events of add-on modules connected to the table.
   Command the BLE SoC for recovering from errors if errors are detected.
   Put a message into the queue connected to the IoT middleware thread.

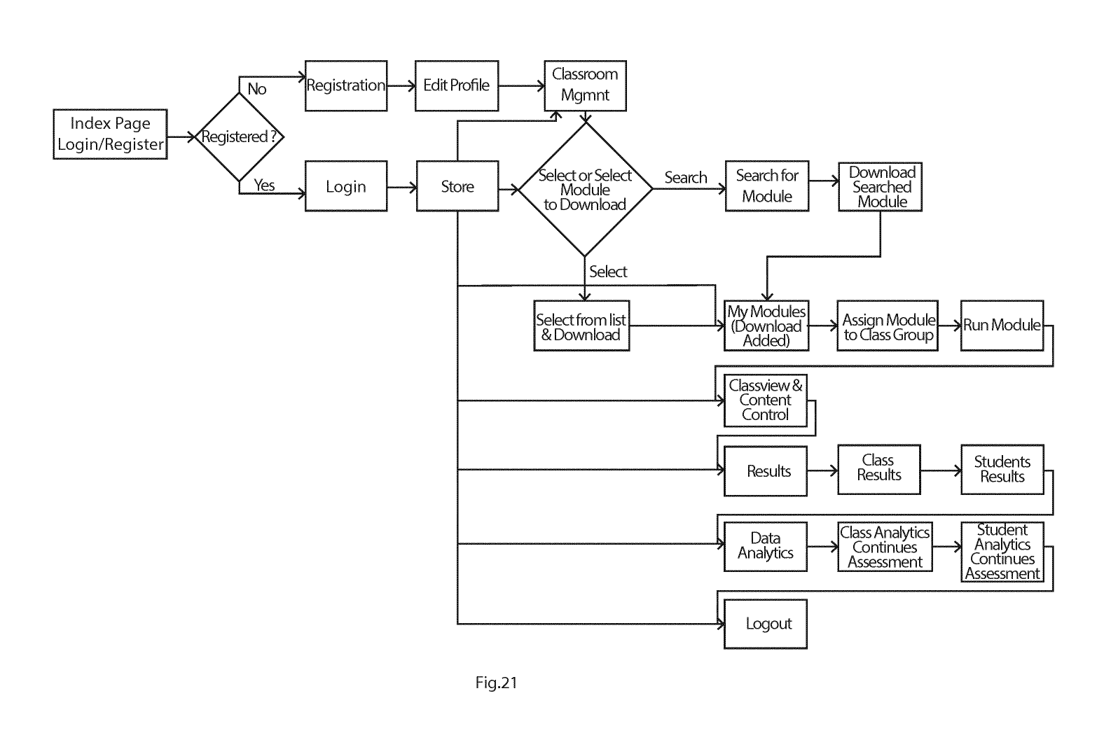

Use Case Normal Flow (FIG. 21)

The teacher logs into the “connected classroom” apparatus 1 web-based application.

Once logged in the access the application “Store” where there are existing educational app modules to select from. There is also search and filter tools to source content per subject, student level etc.

The teacher selects an educational module application already presented from the main “store” user interface.

Once the educational module application is downloaded there is confirmation that the download is has been completed and the application has been added to “My Modules”.

Before running an educational application module, the teacher firstly needs to assign the educational application module to all students in the class. The teacher could alternatively create groups and assign different educational app modules to each individual group.

The teacher runs the selected educational application module assigned to all students.

The teacher selects the “screen share” button to synchronize their tablet with the whiteboard display and to activate the devices 2. The educational app module is now shown on the whiteboard display for the students to view.

The teacher then activates the educational app module, where they select the “Start” button. A task or a question is now displayed on the teachers tablet and on the whiteboard display for the students to view. For example, Question 1 displays 4 apples×3 apples=?

The students are prompted to answer a question or complete a task by tapping the correct answer from an alphanumeric laminate overlay or a printed book, which is placed at fixed positions on top of the interactive school desk.

Students select their answer and provide input by single tapping a number, letter, or picture from alphanumeric characters and symbols laser printed onto the wooden surface of the table. Or alternatively laminate overlays and printed books could be placed at fixed positions on top of the device as there is assigned mappings between the printed book and laminate overlays to the sensor array configuration.

The students are provided with visual feedback as their answer is displayed on an e-ink/LED RGB display that is placed at a fixed position on top of their interactive school desk.

As the students submit their answers, the teacher selects to switch to “Classview” mode by selecting this option from the connected classroom app. They could also format the layout of their application to have dual screen mode, which would display both the educational application module user interface and the Classview mode.

In Classview mode, the teacher views real-time feedback as the students submit their answers. On the user interface they layout of the classroom is shown, where a top view of students and their desks are shown. As students submit their answers, real-time visual feedback is provided to the teacher, where they can assess the input corresponding to each student.

They can assess whether all or if certain students have not yet submitted an answer before proceeding to the next question, they could for example prompt a particular student to submit an answer if they have seen that they have not submitted from viewing the feedback in classview mode.

Once all questions or task in an educational application module are completed, the teacher is prompted with an option to “view class results or “view later”.

The interactive desks are now in “deactivated mode” where input from the desks are not collected.

The teacher selects “view class results” per the completed educational application module. The teacher views an aggregated class result for all the students who have just completed the module. The result is presented in a list view, where there is also a list of student names and their corresponding result.

The teacher selects a “student result” button, which is placed beside the student name in the list view.

Once the teacher selects the student name, the student profile details are displayed, where their answers per each question of the module are displayed and their overall result.

The teacher now wants to view continuous assessment results, such as the overall performance of the class during the school term. However, in a case where the teacher wants to track if there has been and improvement in all students and individual selected students' performance in a particular module. The teacher can therefore react and provide further support or guidance if the results compared to the continuous assessment results show a decline in performance. The teacher selects “Continuous Assessment Menu” from the main panel menu.

Displayed is a table showing the list of Modules completed during the course of the term.

Displayed is the name of the module, the date/time completed, and the average class result.

To get more of a comprehensive perspective is relation to the class progression of performance, the teacher selects “Data Analytics” button.

The teacher can share the student's results.

The teacher can “publish results” results.

The teacher then logs out and exits the connected classroom app.

It will be appreciated that the invention enhances traditional teaching methods using interactive touch sensing technologies which stimulate learning experiences at different levels. School desks have a touch sensing interface, which acts as an input peripheral to the main computing system in the class i.e. (PC, tablet, projector and whiteboard). It provides a participatory platform that enables collaborative and self-managed learning through physical interaction. It adds interactive technologies to the desks by adding a layer of sensors within the wooden surface of the furniture that can sense the touch of the learner, enabling them to interact with the ICT software and infrastructure within the room.

Also, the neighbourhood sensing facilitates seamless grouping of devices for supporting collaborative exercises and activities. Once several devices are grouped and coupled, their touch sensing surfaces behave as a single interface from a user perspective, while still differentiating every of them from the systems perspective.

This interactive layer can be added to a new desk when it is being manufactured but in some cases it can also be retro-fitted to existing classroom furniture thereby providing a classroom upgrade that can leverage the investment that a school may already have made in furniture and other ICT equipment. Once each student's desk is connected, a variety of different modes of interaction would then be possible.

Once installed, the ability to create larger interactive surfaces for students to collaborate together through shared touch and gestures brings new possibilities for social negotiation and shared responsibility, and creates learning experiences that challenge learners' egocentric views and approaches in a way that the traditional classroom experience simply cannot. And, from the perspective of the teacher/educationalist, the apparatus provides a level of control that is hard to achieve with either traditional print-based materials or traditional teacher-instigated classroom exercises.

Teachers can create, or “remix” learning content and resources for use with the interactive tables while, at the same time, gathering key learning data with regard to learner inputs and activities, making learning analytics available to help identify problem areas for learners as they emerge and to flag early on the need for specific teaching interventions or supplementary learning content.

All responses by students can be logged and monitored by the teacher and all of the student response data can be stored in a learning or assessment management system.

The design of the touch sensing array allows implementations of different resolutions depending on the applications and the deployment techniques used for retrofitting the technology in current furniture (underlay/overlay through lamination processes).

Sensitivity of the touch sensing surface may be directly proportional to the thickness of the table top+thickness of the overlay. Minimum size/surface of body of interaction may vary dynamically (i.e. finger/hand depending on the thickness of the table top and/or the overlays).

The touch sensing processing unit may include locally-implemented interpolation algorithms to increase native resolution when possible and/or required by the user/application. Timing constraints may apply regarding response time. It does primary processing and provides relevant data when queried by the core unit. Also, it interfaces with the core unit through, for example, UART/SPI/I2C/USB, and is able to process single touch and multi-touch events. It allows for calibration through firmware of the touch sensing layer, both locally and remotely through web based applications/services.

Also, the touch sensing processing unit allows for dynamic calibration through firmware of the touch sensing layer, depending on the user preferences and/or physical constraints. Also, it includes all necessary conditioning for the touch sensing layer.

The touch sensing processing software may provide health status information arising from interaction with the touch sensing array. The maximum/minimum speed of body of interaction/sensor sampling period may be determined after dynamic testing and calibration. Also, the touch sensing array is designed as to meet noise immunity requirements of table device itself and the class environment.

The invention is not limited to the embodiments described but may be varied in construction and detail. For example, it is not essential that the processing components be located as illustrated. For example there may not be a physically separate gateway and/or teacher computer, and/or server. Any or all of these components may be deployed differently, such as on a particular device, regarded as a master device. Also, the device may take the form of a table top suitable to be placed on a separate desk or table. Also, it is envisaged that the table top may include physical features to assist with alignment of overlay sheets onto the correct position on the dynamic array. An example is one or more ridges along the sides of the dynamic array region.

1-34. (canceled)

35. An educational apparatus comprising:
a plurality of student table top devices, each device comprising:
a board with a touch sensing array, and
a local feedback component physically separate from the touch sensing array and arranged to provide user sensory feedback,
a wireless interface for communication;
a teacher display; and
a controller configured to:
recognise an event associated with touch at a particular position on each student device, including mapping content printed on an overlay sheet placed on the board by a user with location of parts of the sensor array, and
generate a display on the teacher display to provide feedback of events arising from student touching at the student devices.

36. The educational apparatus as claimed in claim 35, wherein the controller is configured to dynamically perform said mapping according to expected printer overlay sheet to be used.

37. The educational apparatus as claimed in claim 35, wherein at least one device has indicia permanently marked on the board surface over a sensing array, and the controller is configured to perform static mapping of content of said indicia with sensor array positions.

38. The educational apparatus as claimed in claim 37, wherein at least one device has indicia permanently marked on the board surface over a sensing array, and the controller is configured to perform static mapping of content of said indicia with sensor array positions; and wherein said permanent indicia are alongside a region for placement of an overlay sheet by a user.

39. The educational apparatus as claimed in claim 35, wherein the board includes a physical guide for registration of an overlay sheet over a sensor array.

40. The educational apparatus as claimed in claim 35, wherein the board includes a physical guide for registration of an overlay sheet over a sensor array; and wherein said guide comprises a ridge for abutment with an overlay sheet.

41. The educational apparatus as claimed in claim 35, wherein the controller is configured to recognise an event by mapping content of an overlay sheet to parts of sensor arrays of a plurality of devices in juxtaposed positions.

42. The educational apparatus as claimed in claim 35, wherein at least some student devices comprise neighbour sensing components for sensing neighbour student devices.

43. The educational apparatus as claimed in claim 35, wherein at least some student devices comprise neighbour sensing components for sensing neighbour student devices; and wherein said neighbour sensing components include wireless interfaces.

44. The educational apparatus as claimed in claim 35, wherein at least some student devices comprise neighbour sensing components for sensing neighbour student devices; and wherein said neighbour sense components are configured to upload to the controller an identifier of a sensed neighbour student device; and wherein the controller is configured to monitor and output information defining relative physical positions of a plurality of student devices; and wherein the controller is configured to identify sub-networks of devices.

45. The educational apparatus as claimed in claim 35, wherein at least some devices are configured to perform inductive coupling sharing of electrical power.

46. The educational apparatus as claimed in claim 35, wherein the controller includes a processing core in each device, said core being configured to co-ordinate components of its associated device; and wherein the controller is configured to arrange a plurality of devices in a group according wireless communication with the devices.

47. The educational apparatus as claimed in claim 35, wherein the controller is configured to recognise as events a pattern of touch by a student as being indicative of student behaviour.

48. The educational apparatus as claimed in claim 35, wherein the sensor array of at least one student device comprises an array of touch sensing electrodes, conditioning circuitry, and a local processing unit for excitation and data acquisition of and from the touch sensors, and in which the touch sensing is based on mutual projected capacitance; and wherein said local processing unit is configured to tune a sensor array sub-section in terms of sensitivity and volume of the electromagnetic field around the sensing elements within the array; and wherein the local processing unit is configured to provide sensitivity for sensing of touch on a book/printed material placed on the board; and wherein the local processing unit is configured to provide sensitivity for sensing of placement of an article on the board.

49. The educational apparatus as claimed in claim 35, wherein the sensor array comprises sub-arrays with different sensitivities.

50. The educational apparatus as claimed in claim 35, wherein each board has a top layer of wood material.

51. The educational apparatus as claimed in claim 35, wherein at least some devices are integrated in desks; and wherein the layer of wood material includes a coating for physical isolation of the wood from the environment.

52. The educational apparatus as claimed in claim 35, wherein the controller is configured to receive data from the student devices through a primary networking interface, and to process and forward data to a local or remote storage location through a secondary network interface.

53. The educational apparatus as claimed in claim 35, wherein the apparatus is arranged to form sub-networks of devices in which a device operates as a gateway of a sub-network; and wherein network socket technology is applied in communication between a teacher software application and student software applications through middleware software.

54. The educational apparatus as claimed in claim 35, wherein the apparatus is arranged to form sub-networks of devices in which a device operates as a gateway of a sub-network; and wherein network socket technology is applied in communication between a teacher software application and student software applications through middleware software; and wherein the middleware is configured to initiate a socket server, and said applications and the devices are configured to listen for messages emitted by the middleware.

55. The educational apparatus as claimed in claim 35, wherein the apparatus is arranged to form sub-networks of devices in which a device operates as a gateway of a sub-network; and wherein network socket technology is applied in communication between a teacher software application and student software applications through middleware software; and wherein a messaging protocol is defined to serve all entities involved in communication for the purpose of differentiating devices in the apparatus, and/or differentiating instances of education modules, and/or differentiating input messages from different devices, and/or managing progresses between instances of the applications.
